(19) United States
(12) Patent Application Publication
(10) Pub. No.: US 2019/0177044 A1
(43) Pub. Date: Jun. 13, 2019

(54) TAMPER EVIDENT CLOSURE

(71) Applicant: Hoffer Plastics Corporation, South Elgin, IL (US)

(72) Inventor: Brian Beringer, South Elgin, IL (US)

(73) Assignee: Hoffer Plastics Corporation

(21) Appl. No.: 16/203,981

(22) Filed: Nov. 29, 2018

Related U.S. Application Data
(60) Provisional application No. 62/597,528, filed on Dec. 12, 2017.

(51) Int. Cl. B65D 41/34; B65D 47/08; B65D 55/02

(52) U.S. Cl. CPC B65D 41/3428; B65D 47/0838; B29L 2031/565; B65D 2101/0038; B65D 55/024

(57) ABSTRACT

A closure for flexible food containers that gives a visual indication of when the cap has been removed from the spout on the closure. The cap has a window that has a filament or bridge forming the bottom of the window. This filament is broken by a tab extending out from the sidewall of the spout when the cap is removed from the closure's spout. This gives the user a visual indication that the cap has been removed.

### CROSS-REFERENCE TO RELATED APPLICATIONS

This application is based on and claims priority of provisional patent application Ser. No. 62/597,528 filed Dec. 12, 2017.

### BACKGROUND AND SUMMARY OF THE INVENTION

This invention relates to closures for use in flexible containers or pouches that generally contain food products.

Various closures have been used for sealing flexible pouches containing liquids, pastes, gels and similar products. Some closures are designed for single use, meaning that once the cap is removed from the spout on the closure, the contents are to be fully consumed and the cap is not designed to be placed back on the spout. In the other instance, the closure is designed to re-seal the spout and to preserve the contents remaining in the pouch.

In either instance, the closure presents a potential safety issue. In some prior art devices, when the top or cap is removed, the closure leaves a band around the opening or spout. Children can attempt to remove it with their teeth, or the band can sometimes be easily pulled off. The band may be swallowed or worse, presents a choking hazard. Applicant's invention provides a removable top or cap that, when removed from the spout, leaves no band around the spout.

Another problem with some prior art devices is that when the cap is removed, it is free to be discarded. However, the removed cap also presents a safety hazard to small children who may swallow the cap. Applicant's invention provides a removable cap, that when removed from the spout, is still attached by a hinge member to the closure.

Another problem with past closures is that if they are designed to re-seal the container, there is often no visual indication the cap was partially or completely removed and then placed back onto the spout. This again presents a safety hazard as one would want to know if the contents are fresh or have been exposed to the atmosphere or, even worse, if the contents of the pouch have been tampered with.

Applicant's invention provides a means by which there is visual indication that the cap has been removed and then placed back onto the spout. Applicant's cap provides such a visual indicator. There is a window section in the cap that has a filament or bridge forming the bottom of the window. This filament is broken when the cap is unscrewed and removed.

### DESCRIPTION OF THE DRAWINGS

FIG. 1 is a top perspective view of the closure with the cap in the open position.

FIG. 2 is a right side view of the closure with the cap in the open position.

FIG. 3 is a top view of the closure with the cap in the open position.

FIG. 4 is a top perspective view of the closure with the cap in the closed position.

FIG. 5 is a front view of the closure with the cap in the closed position.

FIG. 6 is a right side view of the closure with the cap in the closed position.

FIG. 7 is a top view of the closure with the cap in the closed position.

FIG. 8 is a bottom view of the closure with the cap in the closed position.

FIG. 9 is a cross sectional view of the closure with the cap in the closed position.

### DESCRIPTION OF THE PREFERRED EMBODIMENT

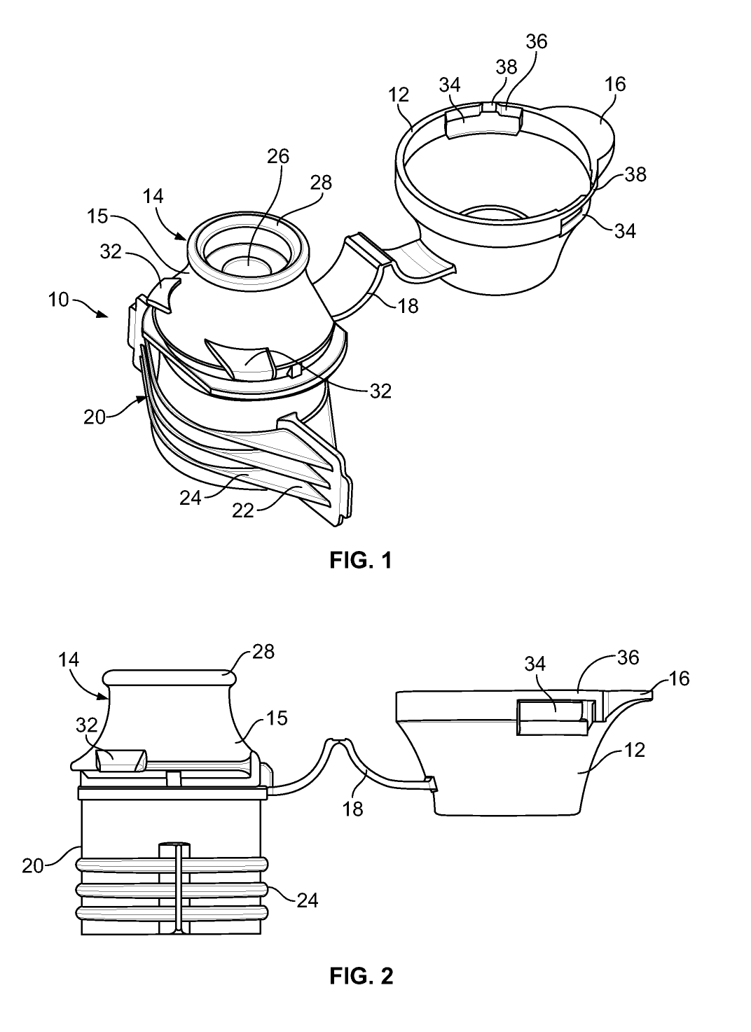

Turning first to FIG. 1, there is illustrated the preferred embodiment of the invention. A closure 10 is illustrated that is designed to be used on flexible containers such as pouches and the like that contain liquid, gel or paste type food products. The closure 10 is comprised of a cap 12 and a spout 14. The cap 12 and spout 14 are generally manufactured from a high density polyethylene thermoplastic material that can be injection molded. Other similar materials can be used that meet the specifications and purpose of the closure 10. Particularly if the container is to contain a food product, the materials from which the closure 10 is manufactured must be approved for food consumption. The spout 14 has a top portion 15 and a bottom portion 20. The cap 12 is attached to the top portion 15 by means of a flexible strap 18 that forms a hinge connection between the cap 12 and the top portion 15.

The cap 12 has a substantially cylindrical sidewall and further has a tab 16 extending out from the sidewall, the tab 16 being the portion grasped by the person that intends to open the closure 10 to access the contents of the pouch. The tab 16 is preferably formed as part of the cap 12 but may be separately manufactured and attached to the cap 12.

The spout 14 as seen in FIGS. 1 and 2 has a spout bottom 20 with an opposite pair of extending wings 22. There are horizontally parallel ribs 24 on the spout bottom that extend out along the extended wings 22. When the spout bottom 20 is inserted into the top of the flexible pouch (not illustrated) the spout bottom 20 is sealed to the interior walls of the pouch and the ribs 24 assist in maintaining a safe, secure and waterproof fit.

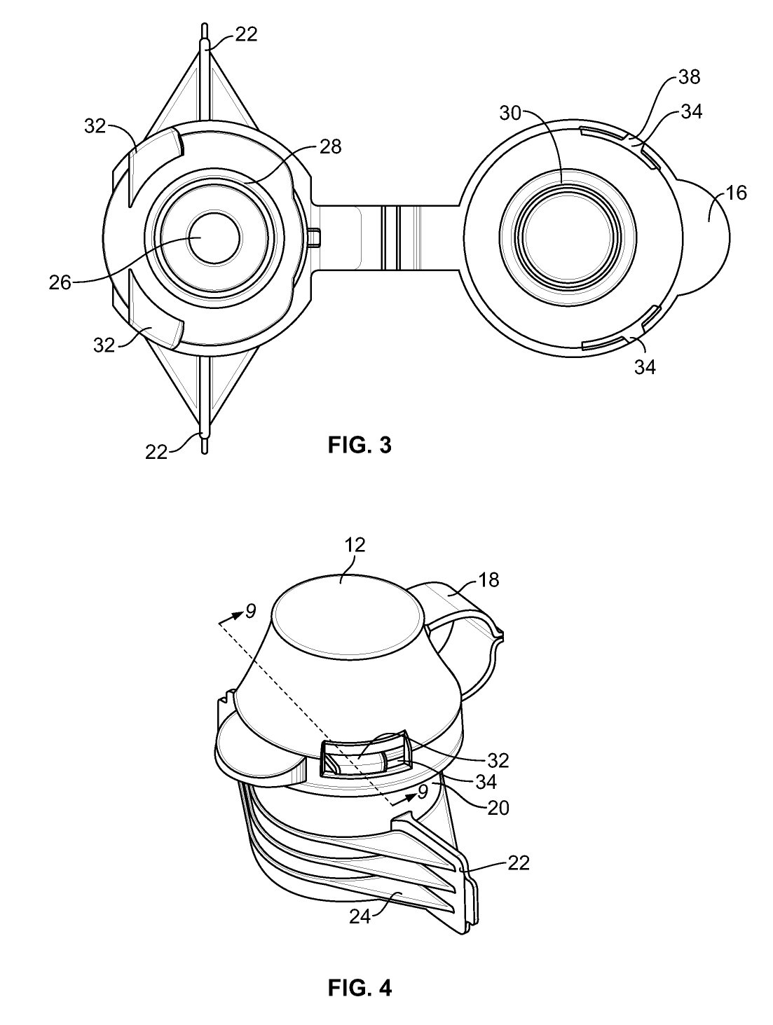

Additional details of the spout 14 are more clearly illustrated in FIGS. 2-3 with the cap 12 in the open position. There is a centrally disposed passageway 26 that extends from the top portion 15 of the spout through the center of the top portion 15 and spout bottom 20. There is a circular collar 28 surrounding the top portion 15. Inside of the cap 12 is a ring 30 that has an inside diameter just slightly greater than the circular collar 28. When the cap 12 is rotated over the top portion 15 into the closed position, as seen in FIG. 4, the ring 30 snaps over the circular collar 28 in a fluid tight seal.

As seen in FIGS. 1-3, there are a pair of outstanding tabs 32 extending out from the top portion 15. The tabs 32 are preferable molded with the top portion 15 so that they are integral with the top portion 15. This gives the tabs 32 the strength needed for their function as set forth below. Although two tabs 32 are illustrated, the closure 10 can be designed with one tab or more than two tabs so long as the spout operates as described herein.

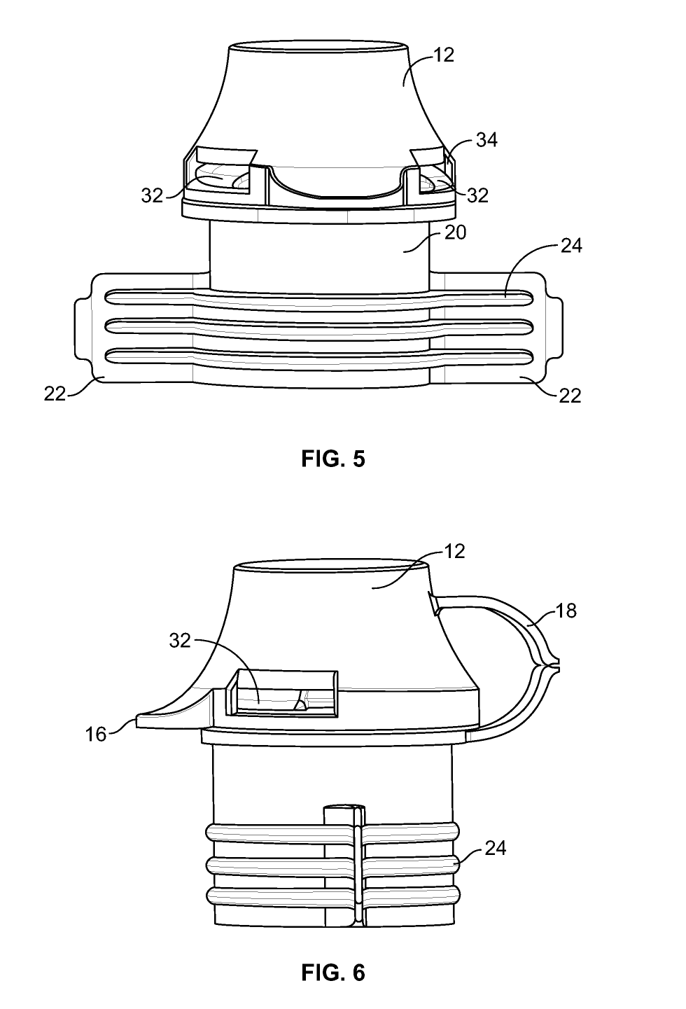

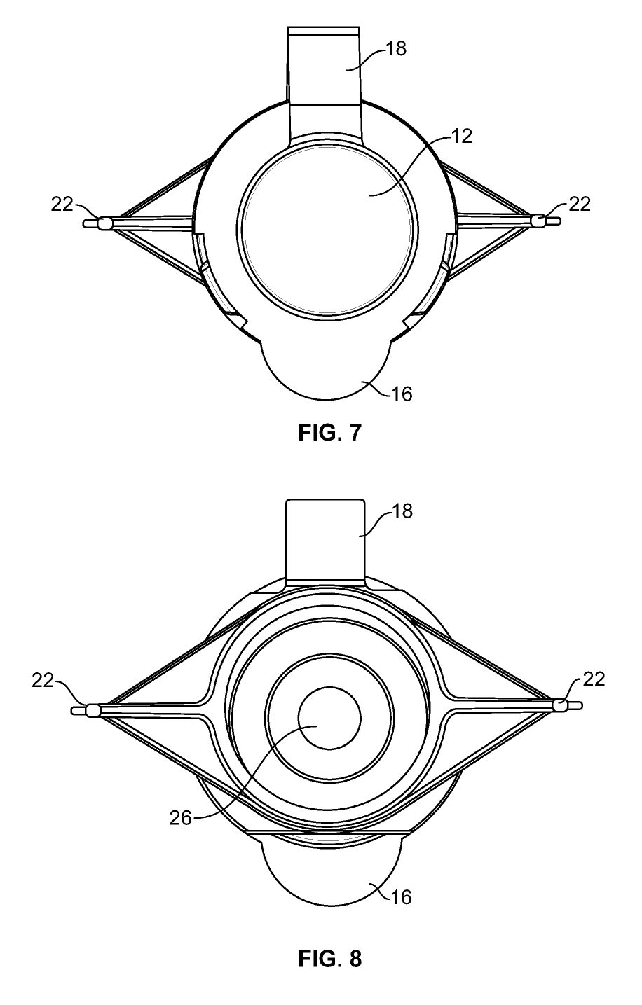

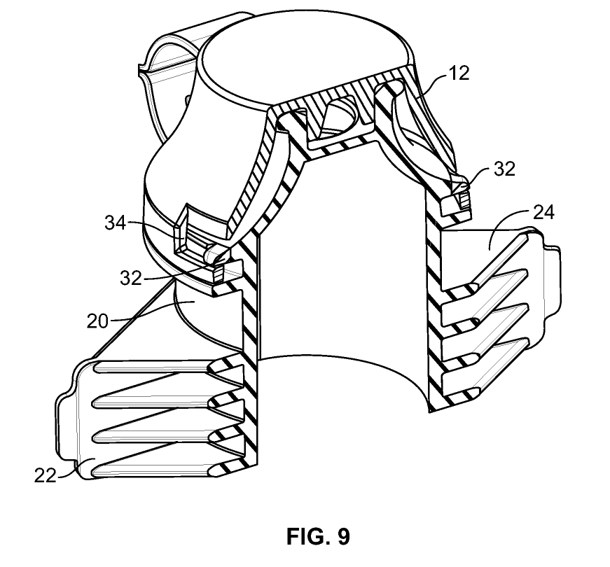

The cap 12 has a pair of rectangular openings 34 at the base of the cap 12. The rectangular openings have a bottom filament or element 36. As best seen in FIG. 1, the filament 36 further has a reduced thickness portion 38 formed within the filament. The rectangular opening 34 is in alignment with the tabs 32 so that the tabs 32 are received within the opening 34 when the cap 12 is rotated from the open position as seen in FIGS. 1-3 to the closed position as seen in FIGS. 4-6. This places the closure 10 in the closed position with the cap 12 sealing the top portion 15 and closing the top of the passageway 26. The tabs 32 have a top surface that tapers slightly downward and away from the top portion 15. This allows the cap 12 and filament 36 to more easily close over the top portion 15. The tabs 32 are closely received in the opening 34 as seen in FIGS. 4-6 in which the closure 10 is in the fully closed position.

In order to open the closure 10, the user holds the pouch in one hand and with the opposite hand lifts the tab 16. Additionally, the user may simultaneously twist the cap 12 which may assist as the user raises the tab 16. Sufficient force is applied by the user so that the filament 36 ruptures along the reduced thickness portion 38 and the cap 12 can be lifted from the top portion 15 of the spout 14. When the cap 12 is fully removed, the cap 12 is still tethered to the spout 14 by the flexible strap 18, thus remaining with the closure 10 and pouch. The ruptured filament 36 gives a visual indication that the cap has been opened.

Thus, there has been provided a tamper evident closure that can, be used with flexible containers or pouches that generally contain food products and provides a visual indication if the closure has been opened. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A closure for a pouch type container comprising:
a spout with a top portion and bottom portion and a central passageway through which a food product can pass from the pouch type container through the spout,
the bottom portion of the spout engaging the container in a fluid tight seal around an exterior surface of the bottom portion,
a cap having a top and a bottom and a substantially cylindrical sidewall, with the bottom having an opening in the cylindrical sidewall of the cap, the opening having opposite sides, and a filament element defining a bottom of the opening,
the spout having a tab with one end attached to the cylindrical sidewall of the spout and the opposite or distal end unattached to the cylindrical sidewall and being a free end extending out from the cylindrical sidewall,
the tab extending into the opening when the cap is mounted on the top portion of the spout, and the tab tearing the filament element when the cap is lifted off of the spout, the ruptured filament element creating a visual indicator that the cap, has been removed from the spout, and the filament element remains attached to the cap when the cap is removed from the spout.

2. The closure of claim 1 and further comprising a flexible strap connecting the cap to the spout wherein the cap remains tethered to the spout by the strap when the cap is removed from the spout.

3. The closure of claim 2 wherein the filament element has a length and a width, with a reduced thickness portion disposed along the length of the filament element for providing a tear point along the length of the filament element.

4. The closure of claim 3 wherein the opening is a substantially rectangular opening in the cylindrical sidewall of the cap, the rectangular opening having opposite sides, and the filament element defining the bottom of the opening.

5. The closure of claim 4 wherein the tab has a tapered top surface that tapers downward and away from the sidewall for providing an angulated surface for the filament element to engage when the cap is mounted onto the spout.

6. The closure of claim 1 and further comprising:
a second opening in the cylindrical sidewall of the cap, the second opening having opposite sides, and a second filament element defining a bottom of the second opening;
a second tab with one end attached to the cylindrical sidewall of the spout and the opposite or distal end unattached to the cylindrical sidewall and being a free end extending out from the cylindrical sidewall;
the second tab extending into the second opening when the cap is mounted on the top portion of the spout, and the second tab tearing the second filament element when the cap is lifted off of the spout.

7. The closure of claim 1 wherein the top portion of the spout has a circumferential collar that engages a sealing ring in the cap to securely close the central passageway.

8. A closure for a pouch type container comprising:
a spout with a top portion and bottom portion and a central passageway through which a food product can pass from the pouch type container through the spout,
the bottom portion of the spout engaging the container in a fluid tight seal around an exterior surface of the bottom portion,
a cap having a top and a bottom and a substantially cylindrical sidewall, with the bottom having an opening in the cylindrical sidewall of the cap, the opening having opposite sides,
a filament element defining a bottom of the opening in the cap, the filament element having a length and a width, with a reduced thickness portion disposed along the length of the filament element for providing a tear point along the length of the filament element,
a flexible strap connecting the cap to the spout wherein the cap remains tethered to the spout by the strap when the cap is removed from the spout,
the spout having a tab with one end attached to the cylindrical sidewall of the spout and the opposite or distal end unattached to the cylindrical sidewall and being a free, end extending out from the cylindrical sidewall, the tab having a tapered top surface that tapers downward and away from the sidewall for providing an angulated surface for the filament element to engage when the cap is mounted onto the spout,
the tab extending into the opening when the cap is mounted on the top portion of the spout, and the tab tearing the filament element when the cap is lifted off of the spout, the ruptured filament element creating a visual indicator that the cap has been removed from the spout, and the filament element remains attached to the cap when the cap is removed from the spout.

9. The closure of claim 8 and further comprising:
a second opening in the cylindrical sidewall of the cap, the second opening having opposite sides, and a second filament element defining a bottom of the second, opening;
a second tab with one end attached to the cylindrical sidewall of the spout and the opposite or distal end unattached to the cylindrical sidewall and being a free end extending out from the cylindrical sidewall;
the second tab extending into the second opening when the cap is mounted on the top portion of the spout, and the second tab tearing the second filament element when the cap is lifted off of the spout.
